(19) United States
(12) Patent Application Publication
(10) Pub. No.: US 2004/0223106 A1
(43) Pub. Date: Nov. 11, 2004

(54) METHOD OF REDUCING A FRINGE FIELD EFFECT IN AN LCD AND RELATED STRUCTURE

(76) Inventor: Hong-Da LIU, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,465

(22) Filed: May 7, 2004

(30) Foreign Application Priority Data
May 9, 2003 (TW) 092112733

(51) Int. Cl. G02F 1/1343

(52) U.S. Cl. 349/139

(57) ABSTRACT

A method of reducing a fringe field effect in an LCD and related structure. The LCD includes a plurality of pixels thereon. The method includes forming a bump on at least a side of each pixel for controlling inclined directions of liquid crystal molecules in a liquid crystal cell, and forming a concave in each pixel for fixing a position of a reverse domain due to different inclined directions. The method and related structure is able to reduce the fringe field effect in a VAN LCOS display or a high resolution LCD. Consequently, the brightness uniformity and contrast ratio are improved while areas with poor display effect are reduced.

### BACKGROUND OF INVENTION

1. Field of the Invention

The present invention relates to a method of reducing a fringe field effect in an LCD and related structure, and more particularly, to a method and related structure adapted in pixels of a VAN (vertical aligned nematic) LCOS display for improving the brightness uniformity and contrast ratio.

2. Description of the Prior Art

Currently, LCD projection is prevailing over all other digital projection technologies. However, several problems still remain to be overcome. One problem is that the limited aperture ratio and low light usage make the brightness insufficient. The other is the heat dissipation difficulty. Since the LCD projector utilizes high luminant halogen filament bulbs which generate heat when illuminating, the heat dissipation problem reduces the lifetime of the halogen filament bulbs. Therefore, the LCOS (liquid crystal on silicon) projector, such as a VAN (vertical aligned nematic) LCOS display, has been highly developed since it adopts standard semiconductor processes and has the advantages of high resolution and high aperture ratio.

FIG. 1 is a schematic diagram of a conventional VAN LCOS display. As shown in FIG. 1, the conventional VAN LCOS display includes a silicon substrate 10, an insulating layer 12 positioned on the silicon substrate 10, a passivation layer 14 positioned above the insulating layer 12, two metal layers 16 and 18, and an aluminum reflective layer 20. The metal layer 16 is connected to switch components (not shown), the metal layer 18 is connected to a barrier layer (not shown), and the aluminum reflective layer 20 is used to reflect light beams. The conventional VAN LCOS display further includes liquid crystal molecules 22, two alignment layers 24, an ITO electrode 26, and a glass substrate 28. The liquid crystal molecules 22 are positioned above the passivation layer 14 and in between the two alignment layers 24, the ITO electrode 26 is positioned on the alignment layer 24, and the glass substrate 28 is positioned on the ITO electrode 26.

FIG. 2 is a schematic diagram illustrating a fringe field effect. As shown in FIG. 2, when the distance between pixels in an LCD panel becomes closer, the diffraction effect and the fringe field effect may occur. The diffraction effect results from the pixel electrodes which function as a raster. The fringe field has an extent 32 proportional to a cell gap 30 of the LCD panel. In other words, the larger the cell gap 30, the broader the extent 32.

As technologies progress, LCDs with high resolutions have become standard. However, the fringe field effect is not desirable when pursuing high resolution. Therefore, a method of reducing and controlling the fringe field effect for improving the brightness uniformity and contrast ratio is highly needed.

### SUMMARY OF INVENTION

It is a primary objective of the present invention to provide a method of reducing a fringe field effect in an LCD and related structure, particularly in the situation when the distance between two adjacent pixels is less than twice of the cell gap.

According to the claimed invention, a method of reducing a fringe field effect in an LCD and related structure are disclosed. The LCD includes a substrate having a plurality of pixels arranged in arrays, and each pixel corresponds to a liquid crystal cell. The method includes forming a bump on at least a side of each pixel for controlling inclined directions of liquid crystal molecules in a liquid crystal cell, and forming a concave in each pixel for fixing a position of a reverse domain due to the different inclined directions of the liquid crystal molecules.

The structure includes a first substrate having a pixel defined thereon, a liquid crystal cell, at least a bump, at least a concave, and a second substrate. The first substrate has a bottom layer thereunder. The liquid crystal cell has a plurality of liquid crystal molecules positioned above the first substrate. The at least bump is positioned on the first substrate and on at least two opposites of the pixel for controlling inclined directions of the liquid crystal molecules. The concave is positioned on the first substrate for fixing a position of a reverse domain due to different inclined directions of the liquid crystal molecules above the concave. The second substrate is positioned above the liquid crystal cell.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a conventional VAN LCOS display.

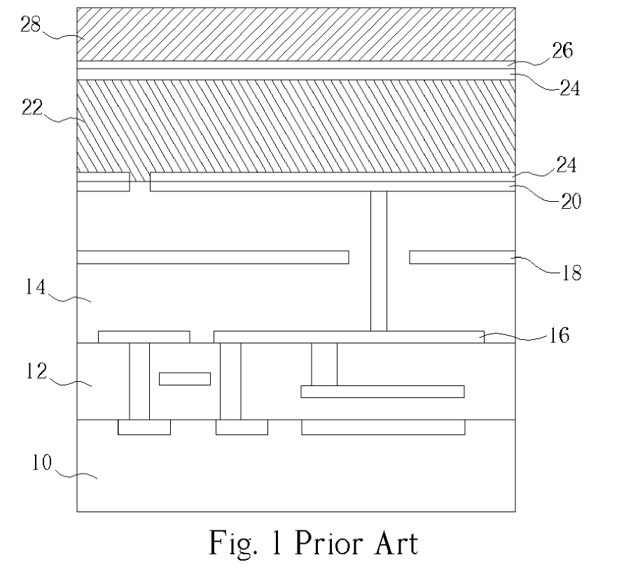

FIG. 2 is a schematic diagram illustrating a fringe field effect.

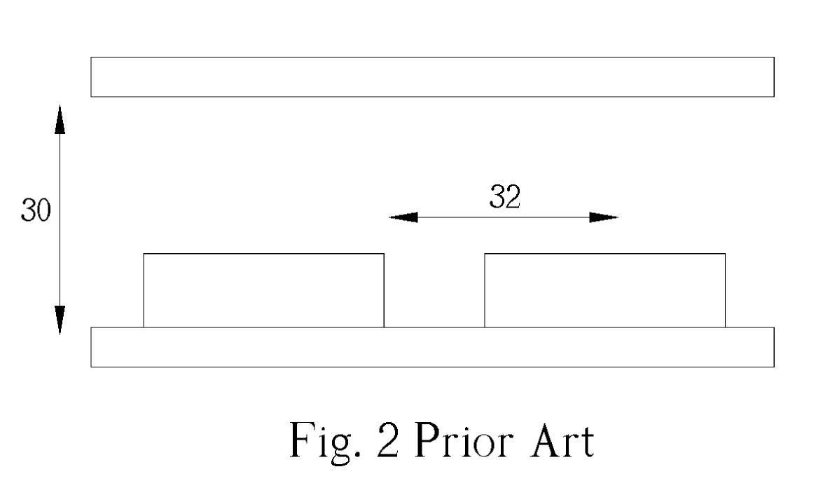

FIG. 3 is a schematic diagram of a VAN LCOS display in a power-off situation according to the present invention.

FIG. 4 is a schematic diagram of the VAN LCOS display shown in FIG. 3 in a power-on situation.

FIG. 5 is a schematic diagram of the bumps and the concave shown in FIG. 3.

FIG. 6 is a top view of the VAN LCOS display in a power-off situation.

FIG. 7 is a top view of the VAN LCOS display shown in FIG. 6 in a power-on situation.

FIG. 8 is a top view of another VAN LCOS display in a power-off situation.

FIG. 9 is a top view of the VAN LCOS display shown in FIG. 8 in a power-on situation.

FIG. 10 is a schematic diagram illustrating a reverse domain.

FIG. 11 is a cell gap vs. reverse domain chart.

FIG. 12 is a chart illustrating relations between the height of bump and response time.

FIG. 13 is a schematic diagram of a VAN LCOS display when the frame-plus-bias driving method is adopted.

FIG. 14 is a schematic diagram of another VAN LCOS display when the frame-plus-bias driving method is adopted.

### DETAILED DESCRIPTION

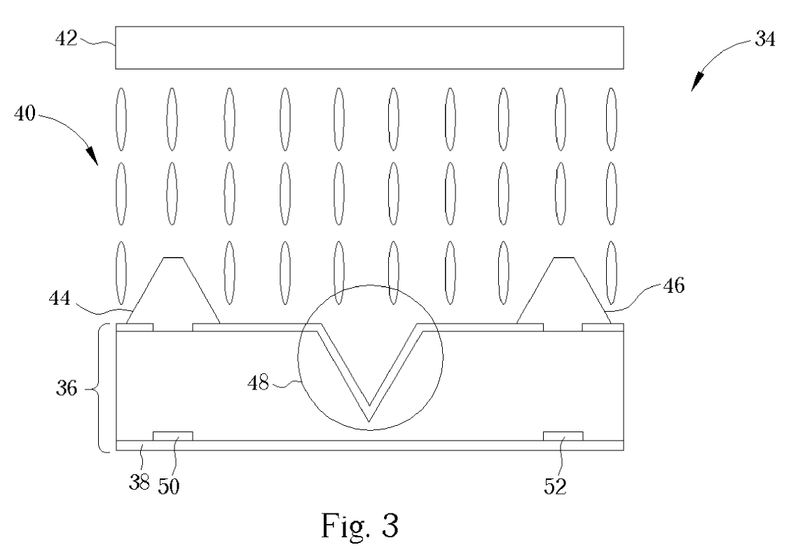

FIG. 3 is a schematic diagram of a VAN LCOS display 34 in a power-off situation according to the present invention. As shown in FIG. 3, the VAN LCOS display 34 includes a first substrate 36 having a bottom layer 38, a liquid crystal cell 40 having a plurality of vertically aligned liquid crystal molecules positioned above the substrate 36, a second substrate 42 positioned above the liquid crystal cell 40, two bumps 44 and 46 positioned on two opposite sides of a pixel of the first substrate 36, and a concave 48 positioned on the first substrate 36 between the bumps 44 and 46. The bumps 44 and 46 are for controlling inclined directions of the liquid crystal molecules of the liquid crystal cell 40, and the material of the bumps 44 and 46 include silicon oxide, silicon nitride, and other inorganic materials so as to reduce the fringe field effect. The concave 48 is used to fix a position of a black line due to different inclined directions of the liquid crystal molecules in the liquid crystal cell 40. It is to be noted that the concave 48 can be alternatively positioned anywhere between the two bumps 44 and 46. Preferably, the concave 48 is positioned halfway between the bumps 44 and 46. In such a case, the liquid crystal molecules alongside the concave 48 are arranged symmetrically, and thereby reveal identical optical characteristics. In addition, if a frame-plus-bias inverse driving method is applied, two electrodes 50 and 52 corresponding to the bumps 44 and 46 must be installed on the bottom layer 38. In such case, the bumps 44 and 46 can generate an electric field so as to control the inclined directions of the liquid crystal molecules in the liquid crystal cell 40.

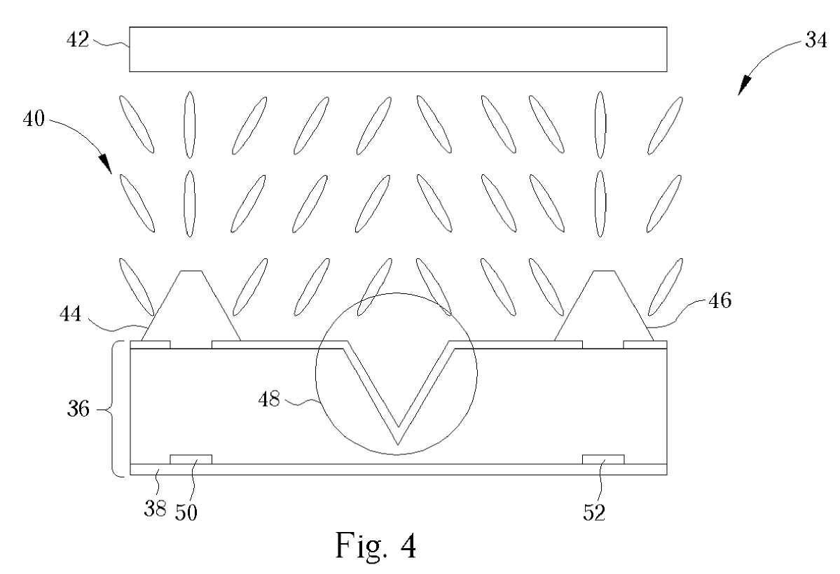

FIG. 4 is a schematic diagram of the VAN LCOS display 34 shown in FIG. 3 in a power-on situation. As shown in FIG. 4, while power is provided, the bumps 44 and 46 enable the liquid crystal molecules in the liquid crystal cell 40 to incline from the bumps 44 and 46 to the concave 48 such that a reverse domain is formed. The reverse domain causes the brightness to be uneven, and therefore the purpose of the concave 48 is to fix the position of the reverse domain right above the concave 48.

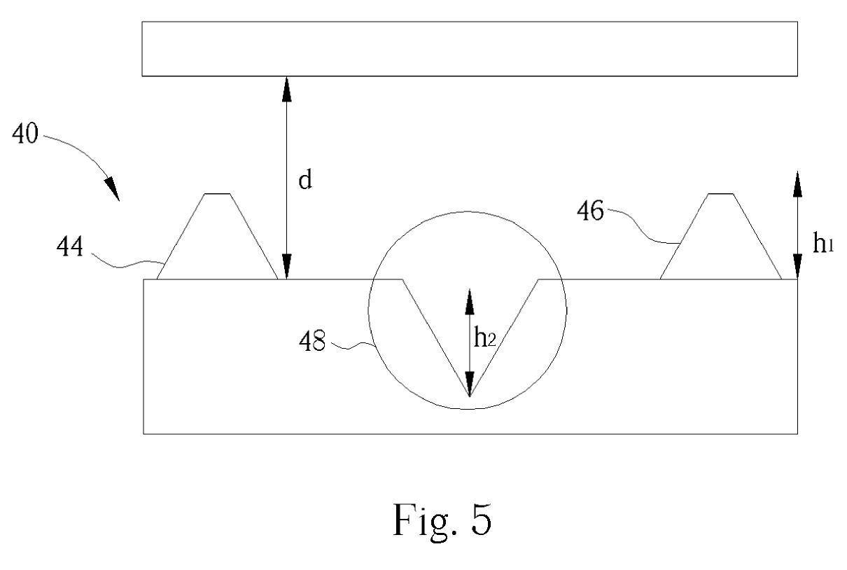

FIG. 5 is a schematic diagram of the bumps 44 and 46, and the concave 48 shown in FIG. 3. As shown in FIG. 5, the liquid crystal cell 40 has a cell gap d, the bumps 44 and 46 have a same height h1, and the concave 48 has a depth h2. The bumps 44 and 46, and the concave 48 are used to control the inclined directions of the liquid crystal molecules in the liquid crystal cell 40. By way of adjusting the relations among the cell gap d, the height h1, and the depth h2, the brightness uniformity and the contrast ratio are improved while the area having a poor display effect is reduced. According to the present invention, the height h1 of the bumps 44 and 46, the depth h2 of the concave 48, and the cell gap d of the liquid crystal cell 40 are consistent with the following relations.

1/15≦h1/d≦1 (EQ-1)

1/50≦h2/d≦⅓ (EQ-2)

According to EQ-1 and EQ-2, proper values of h1 and h2 can be obtained. The bumps 44 and 46 have a height h1 ranging from 0.3 μm to 3 μm, and a width ranging from 0.3 μm to 20 μm. The concave 48 has a depth ranging from 0.05 μm to 3 μm, and a width ranging from 0.05 μm to 20 μm.

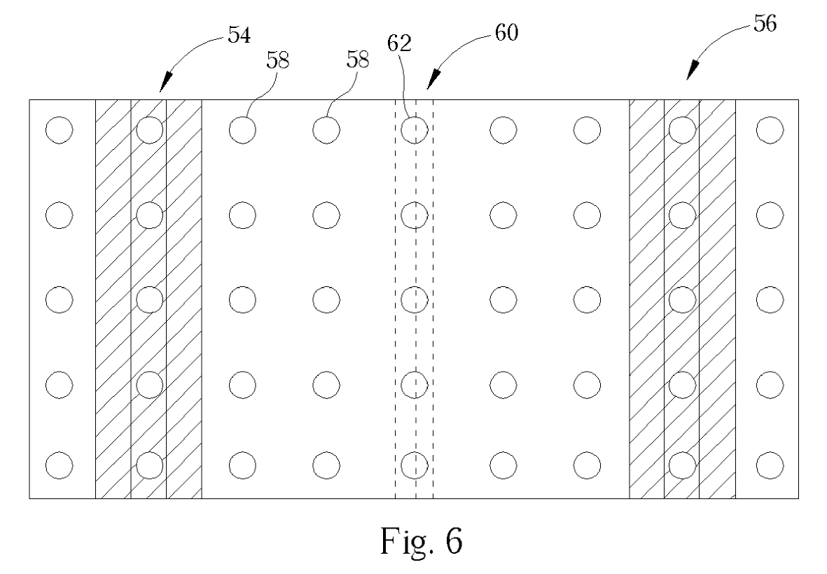

FIG. 6 is a top view of the VAN LCOS display in a power-off situation. As shown in FIG. 6, the VAN LCOS display includes two bar bumps 54 and 56, and a bar concave 60. The bar bumps 54 and 56 have a bar-shaped structure and are positioned at two opposite sides of a pixel for controlling the inclined directions of liquid crystal molecules 58. The bar concave 58 also has a bar-shaped structure in parallel with the bar bumps 54 and 56, and is positioned between the bar bumps 54 and 56 for fixing a disclination line 62 generated when the liquid crystal molecules 58 are inclined.

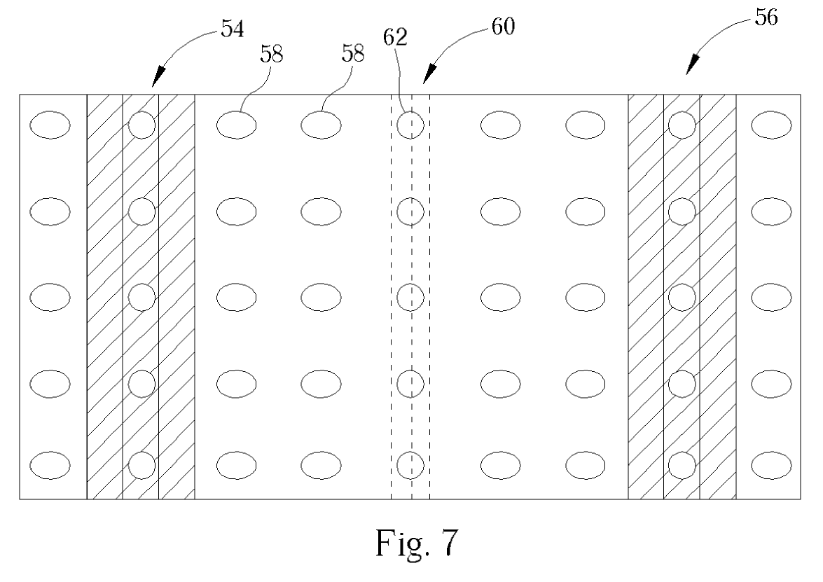

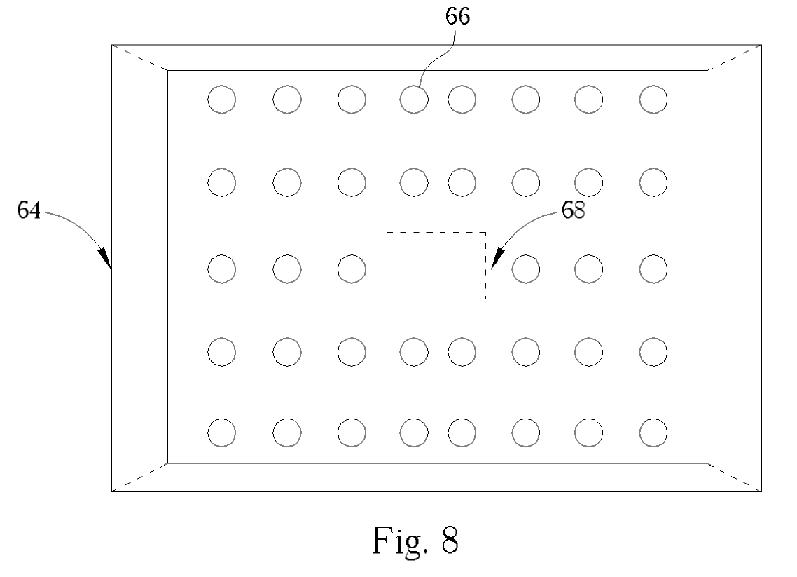

FIG. 7 is a top view of the VAN LCOS display shown in FIG. 6 in a power-on situation. As shown in FIG. 7, the liquid crystal molecules 58 are inclined from the bar bumps 54 and 56 toward to the bar concave 60 when power is provided. The disclination line 62 is a black line generated by the liquid crystal molecules 58 above the bar concave 60 or by the liquid crystal molecules 58 close to the bar concave 60. Consequently, the position of the disclination line 62 is decided by the position of the bar concave 60. FIG. 8 is a top view of another VAN LCOS display in a power-off situation. As shown in FIG. 8, the VAN LCOS display includes a circular bump 64 around a pixel for controlling inclined directions of liquid crystal molecules 66, and a concave 68 positioned within the circular bump 64 for fixing a black dot generated while the molecules 68 are inclined.

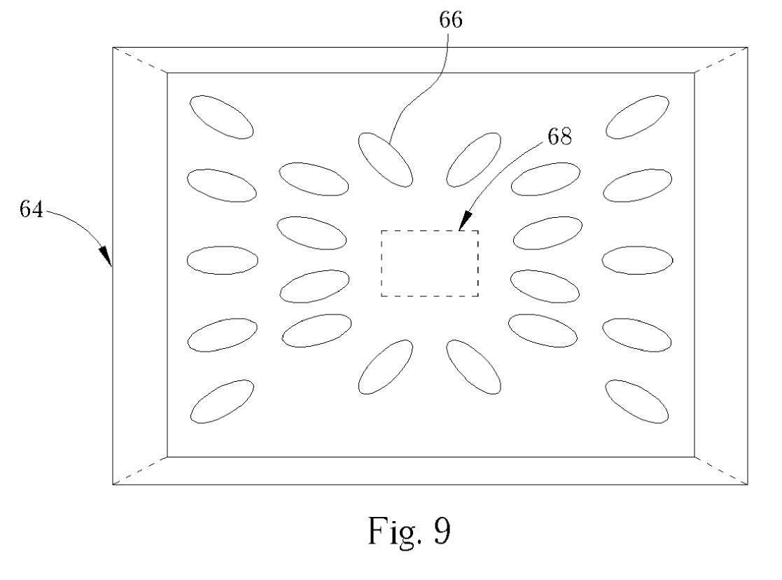

FIG. 9 is a top view of the VAN LCOS display shown in FIG. 8 in a power-on situation. As shown in FIG. 9, the liquid crystal molecules 66 are inclined from the circular bump 64 toward the concave 68. The concave 68 is used to fix the black dot resulting from the liquid crystal molecules 66 above the concave 68 or the liquid crystal molecules 66 close to the concave 68. Similarly, the position of the black dot is decided by the position of the concave 68. Preferably, the concave 68 is positioned at a symmetrical center of the circular bump 64. Accordingly, the liquid crystal molecules 66 are arranged symmetrically, and render the VAN LCOS display a better display effect.

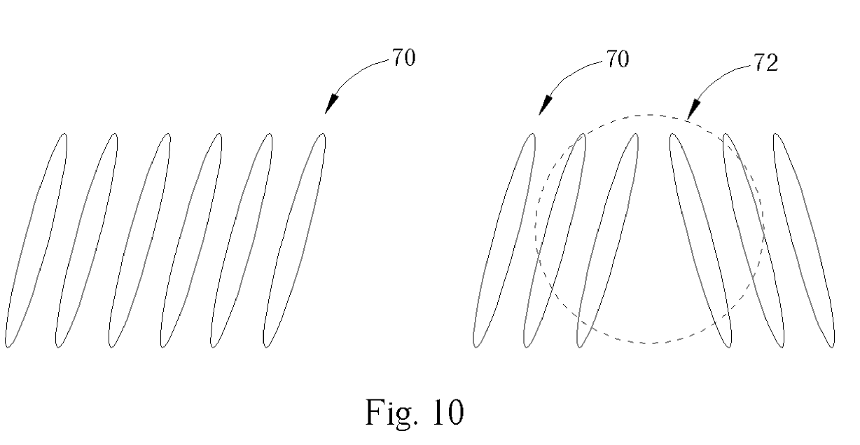

FIG. 10 is a schematic diagram illustrating a reverse domain. As shown in FIG. 10, while the inclined directions of liquid crystal molecules 70 are inconsistent, a reverse domain 72 occurs. The reverse domain 72 causes the brightness to be uneven. Therefore, a concave is adopted to fix the position of a black line or a black dot resulting from the reverse domain 72.

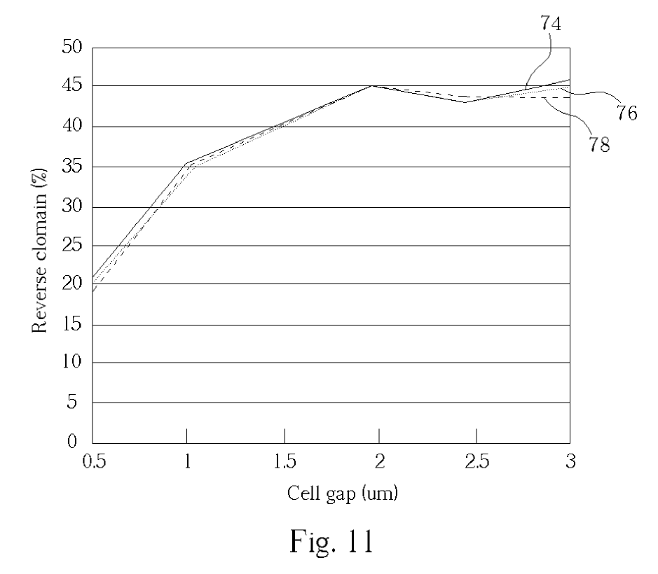

FIG. 11 is a cell gap vs. reverse domain chart, where different curves are obtained in different phase differences (Δnd). As shown in FIG. 11, a curve 74 is obtained when Δnd equals 270 nm, a curve 76 is obtained when Δnd equals 300 nm, and a curve 78 is obtained when Δnd equals 330 nm. At a fixed cell gap, the variation of phase difference is weakly correlated with the extent of reverse domain. However, at a fixed phase difference, the variation of liquid crystal cell gap is strongly correlated with the extent of reverse domain. As a result, the correlation between the liquid crystal cell gap and the extent of reverse domain is more evident than the correlation between the phase difference and the extent of reverse domain.

The VAN LCOS display of the present invention is free to adopt different driving methods such as dot inversion, frame inversion, and frame-plus-bias inversion, and none of these methods has a light leakage problem in the dark state. Since there are no light leakage problems, the contrast ratio, which is a brightness ratio of a luminous state to that of a dark state, is high. However, the dot inversion method has the disadvantage of uneven brightness that causes a large extent of reverse domain. Therefore, the frame-plus-bias inversion driving method is preferred.

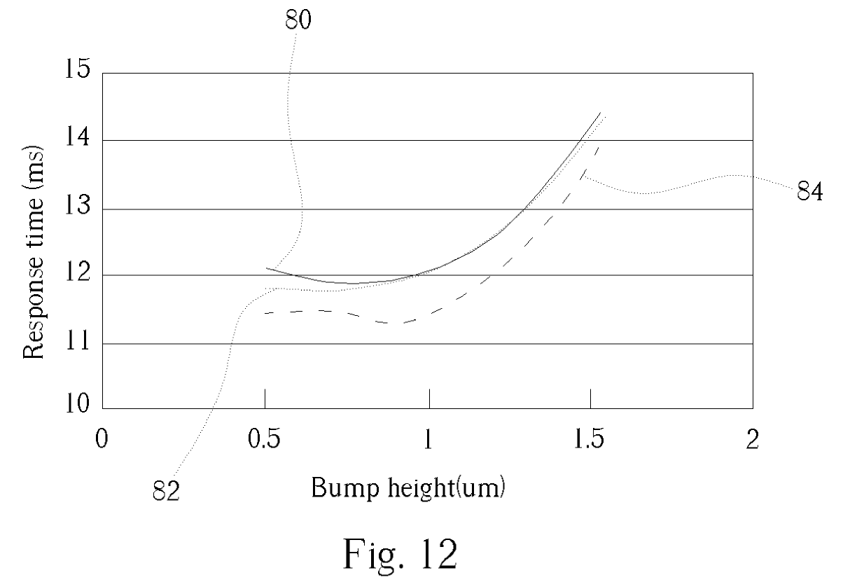

FIG. 12 is a chart illustrating relations between the height of bump and response time, where the phase difference (Δnd=275 nm) and the liquid crystal cell gap (d=2.0 μm) are both fixed. As shown in FIG. 12, a curve 80 is obtained when the depth of the concave is 0 μm, a curve 82 is obtained when the depth of the concave is 0.1 μm, and a curve 84 is obtained when the depth of the concave is 0.5 μm. While the bump and the concave are absent, different modes of LCDs, such as ECB mode, TN mode, INV-TN mode, etc., suffer from the uneven brightness problem due to the fringe field effect. The presence of the bump can reduce the fringe field effect, and the presence of the concave can fix the position of the disclination line. In other words, the reverse domain is formed right above the concave. It is worth noting that the phase difference is selected according to different modes of LCDs to enhance the function of the bump and the concave. Preferably, the phase difference is between 150 nm to 410 nm.

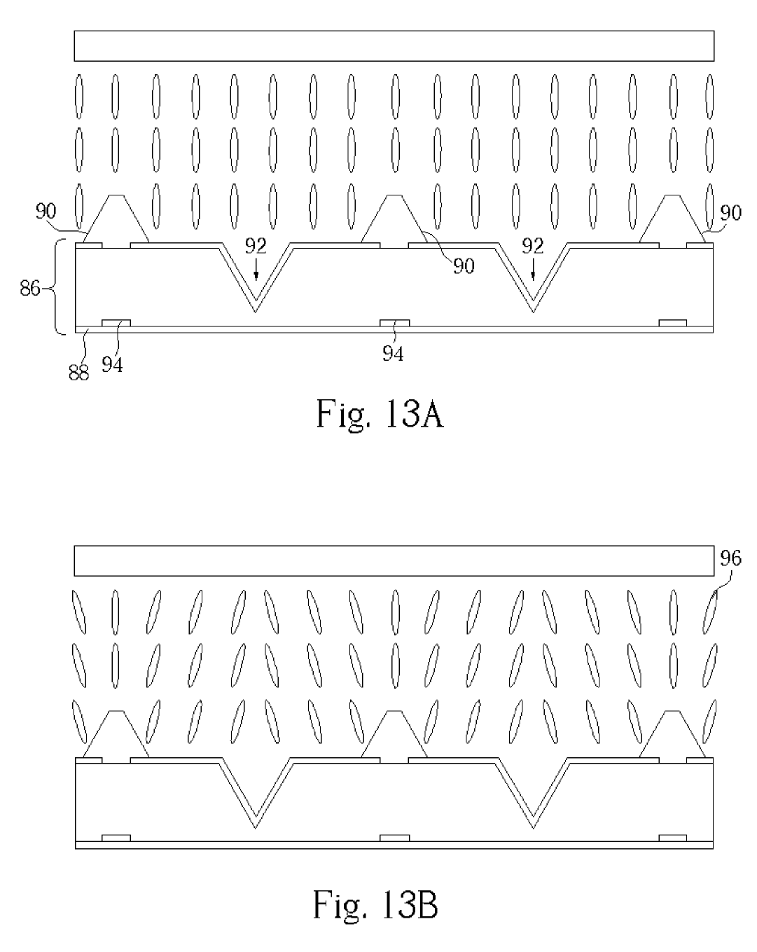

FIG. 13 is a schematic diagram of a VAN LCOS display when the frame-plus-bias driving method is applied, where FIG. 13A shows a power-off situation, and FIG. 13B shows a power-on situation. As shown in FIG. 13A, a plurality of bumps 90 are formed between adjacent pixels on a substrate 86 which has a bottom layer 88 thereunder. A plurality of concaves 92 are then formed on the substrate 86 between two adjacent bumps 90. Electrodes 94 corresponding to the bumps 90 are formed on the bottom layer 88 to generate an electric field. As shown in FIG. 13B, when power is provided, only liquid crystal molecules 96 positioned above the bumps 90 are not influenced by the electric field. The rest of the liquid crystal molecules 96 are inclined from the bumps 90 toward the concaves 92, and thereby form reverse domains positioned above each concave 92.

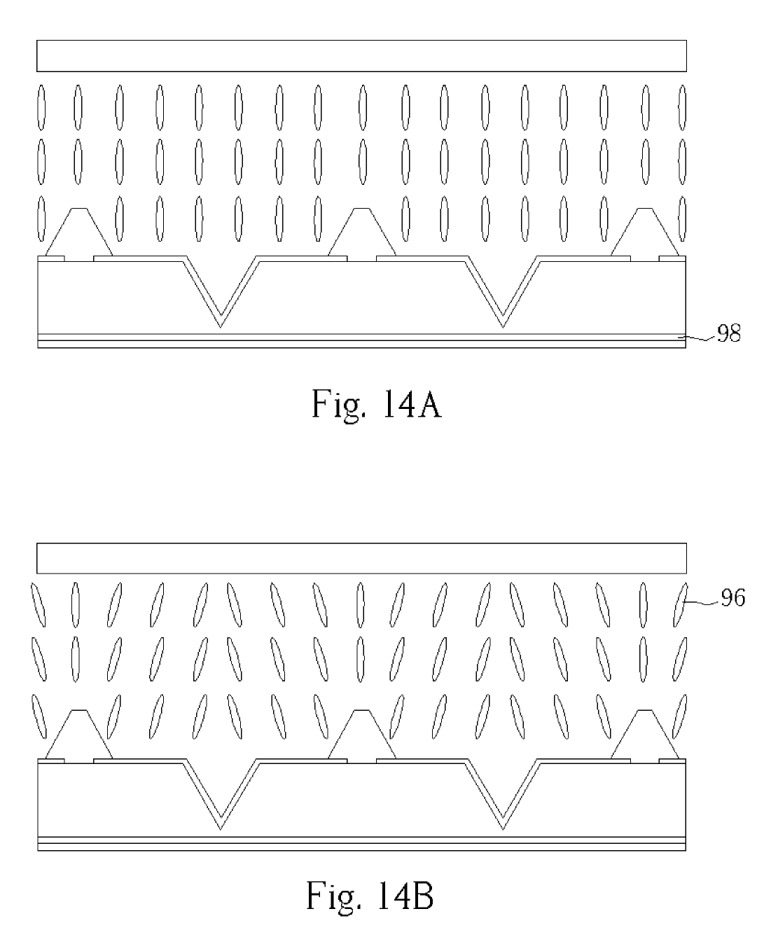

FIG. 14 is a schematic diagram of another VAN LCOS display when the frame-plus-bias driving method is adopted where FIG. 14A shows a power-off situation, and FIG. 14B shows a power-on situation. The differences between this VAN LCOS display and the VAN LCOS display shown in FIG. 13 is that an electrode layer 98 replaces the electrodes 94 to generate an electric field.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of reducing a fringe field effect in an LCD, the LCD comprising a substrate having a plurality of pixels arranged in arrays, each pixel corresponding to a liquid crystal cell, the method comprising the following steps:
forming a bump on at least a side of each pixel for controlling inclined directions of liquid crystal molecules of each liquid crystal cell; and
forming a concave in each pixel of the substrate for fixing a position of a reverse domain due to the different inclined directions of the liquid crystal molecules in each liquid crystal cell.

2. The method of claim 1 wherein each liquid crystal cell is a liquid crystal cell of an LCOS (liquid crystal on silicon) display.

3. The method of claim 1 wherein each liquid crystal cell is driven by methods comprising dot inversion, frame inversion, and frame-plus-bias inversion.

4. The method of claim 1 wherein modes of the liquid crystal cell comprise TN (twisted nematic), reflective TN, ECB (electric controlled birefringence), VAN (vertical aligned nematic), and INV-TN (inverse twisted nematic).

5. The method of claim 1 wherein the bump is positioned on two opposite sides of each pixel, and the concave is positioned halfway between the bumps in each pixel.

6. The method of claim 1 wherein each bump is positioned around each pixel, and each concave is positioned at a symmetrical center of an area encompassed by the bump.

7. The method of claim 1 wherein the substrate further comprises a bottom layer, and the method further comprises forming an electrode layer on the bottom layer while a frame-plus-bias inversion driving method is applied.

8. The method of claim 7 wherein the electrode layer comprises at least an electrode, each electrode being positioned underneath the bump and corresponding to the bump for implementing the frame-plus-bias driving method.

9. A structure for reducing a fringe field effect in an LCD, the structure comprising:
a first substrate, the first substrate having a bottom layer thereunder and a pixel defined thereon;
a liquid crystal cell comprising a plurality of liquid crystal molecules positioned above the first substrate;
at least a bump positioned on at least two opposite sides of the pixel of the first substrate for controlling inclined directions of the liquid crystal molecules;
a concave positioned in the pixel of the first substrate for fixing a position of a reverse domain due to the different inclined directions of the liquid crystal molecules above the concave; and
a second substrate positioned above the liquid crystal cell.

10. The structure of claim 9 wherein the liquid crystal cell is a liquid crystal cell of an LCOS (liquid crystal on silicon) display.

11. The structure of claim 9 wherein the bump comprises at least an insulating material.

12. The structure of claim 11 wherein the insulating material comprises silicon oxide, silicon nitride, and inorganic materials.

13. The structure of claim 9 wherein the liquid crystal cell is driven by methods comprising dot inversion, frame inversion, and frame-plus-bias inversion.

14. The structure of claim 9 wherein modes of the liquid crystal cell comprise TN (twisted nematic), reflective TN, ECB (electric controlled birefringence), VAN (vertical aligned nematic), and INV-TN (inverse twisted nematic).

15. The structure of claim 9 wherein the liquid crystal cell has a phase difference ranging from 150 nm to 410 nm.

16. The structure of claim 9 wherein the bump is bar-shaped.

17. The structure of claim 9 wherein the bump is circular.

18. The structure of claim 9 wherein the concave is bar-shaped.

19. The structure of claim 9 wherein the liquid crystal molecules incline from the bump toward the concave.

20. The structure of claim 9 wherein the concave fixes a position generated due to contrary inclined directions of the liquid crystal molecules close to the concave.

21. The structure of claim 9 wherein the first substrate further comprises at least an electrode positioned on the bottom layer, each electrode being positioned directly underneath the bump for implementing a frame-plus-bias inversion method.

22. The structure of claim 9 wherein the first substrate further comprises an electrode layer positioned on the bottom layer for implementing a frame-plus-bias inversion method.

23. The structure of claim 9 wherein the bump has a height ranging from 0.3 μm to 3 μm.

24. The structure of claim 9 wherein the bump has a width ranging from 0.3 μm to 20 μm.

25. The structure of claim 9 wherein the liquid crystal cell has a cell gap, the bump has a height, and a ratio of the height to the cell gap ranges from 1/15 to 1.

26. The structure of claim 9 wherein the concave has a depth ranging from 0.05 μm to 3 μm.

27. The structure of claim 9 wherein the concave has a width ranging from 0.05 μm to 20 μm.

28. The structure of claim 9 wherein the liquid crystal cell has a cell gap, the concave has a depth, and a ratio of the depth to the cell gap ranges from 1/50 to ⅓.
